(19) United States
(12) Patent Application Publication
(10) Pub. No.: US 2007/0055798 A1
(43) Pub. Date: Mar. 8, 2007

(54) Apparatus and method to adjust one or more input/output parameters for a computing system

(76) Inventors: Jonathan W. Ain, Tucson, AZ (US); Nathaniel L. Billups, Tucson, AZ (US); James P. Henry, Tucson, AZ (US); Craig A. Klein, Tucson, AZ (US); Eric E. McGar, Vail, AZ (US); Arlen L. Pederson, Tucson, AZ (US); Eric A. Vega, Vail, AZ (US)

Correspondence Address: DALE F. REGELMAN, 4231 S. FREMONT AVENUE, TUCSON, AZ, 85714, US

(21) Appl. No.: 11/218,467

(22) Filed: Aug. 31, 2005

(51) Int. Cl. G06F 3/00

(52) U.S. Cl. 710/58

(57) ABSTRACT

A method is disclosed to adjust one or more input/output parameters for a computing system comprising at least one computing device, one or more data storage devices, and one or more variable I/O parameters. The method establishes a change value and a stabilization period for each of the one or more I/O parameters. The method determines a current I/O rate, selects the (i)th I/O parameter, where that (i)th I/O parameter comprises the (i)th current value. The method then sets the (i)th I/O parameter to equal the (i)th current value modified by the (i)th change value, calculates an adjusted I/O rate, and determines if the adjusted I/O rate is less than the current I/O rate. If the adjusted I/O rate is not less than the current I/O rate, the method saves the adjusted (i)th I/O parameter as the (i)th current value. The method iteratively adjusts the (i)th I/O parameter until that adjusted I/O rate is less than the previous I/O rate, then saves the (i)th I/O parameter value minus the change value as the new current value.

### FIELD OF THE INVENTION

This invention relates to an apparatus and method to adjust one or more input I output parameters for a computing system. In certain embodiments, the invention relates to an apparatus and method to adjust one or more input/output parameters for an information storage and retrieval system.

### BACKGROUND OF THE INVENTION

As a general matter, a computing systems comprises at least one computing devices in communication with one or more data storage devices. The one or more computing devices and the one or more data storage devices bidirectionally exchange data. In certain embodiments, a computing system comprises an information retrieval system comprising, inter alia, a plurality of data storage devices.

Information storage and retrieval systems are used to store information provided by one or more host computer systems. Such information storage and retrieval systems receive requests to write information to one or more data storage devices, and requests to retrieve information from those one or more data storage devices. In certain embodiments, upon receipt of a read request the system recalls information from the one or more data storage devices and moves that information to a data cache. Thus, the computing system is continuously moving information to and from a plurality of data storage devices, to and from a data cache, and to and from one or more interconnected host computers.

What is needed is an apparatus and method to autonomically adjust one or more input/output (“I/O”) parameters to optimize the overall data flow, i.e. the I/O rate, between the one or more computing devices and the one or more data storage devices.

### SUMMARY OF THE INVENTION

Applicants' invention comprises a method to adjust one or more I/O parameters for a computing system. The method provides a computing system comprising at least one computing device, one or more data storage devices, and one or more variable I/O parameters. The method establishes a change value and a stabilization period for each of the one or more I/O parameters. The method determines a current I/O rate, selects the (i)th I/O parameter, where that (i)th I/O parameter comprises the (i)th current value.

The method then sets the (i)th I/O parameter equal to the (i)th current value plus the (i)th change value, calculates an adjusted I/O rate, and determines if the adjusted I/O rate is less than the current I/O rate. If the adjusted I/O rate is not less than the current I/O rate, the method saves the adjusted (i)th I/O parameter as the (i)th current value. The method iteratively adjusts the (i)th I/O parameter until the resulting I/O rate is less than the previous I/O rate.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram showing one embodiment of Applicants' information storage and retrieval system;

FIG. 2 is a block diagram showing the information storage and retrieval system of FIG. 1 comprising three storage arrays;

FIG. 3 is a flow chart summarizing certain steps of Applicants' method;

FIG. 4 is a flow chart summarizing certain additional steps of Applicants' method; and

FIG. 5 is a flow chart summarizing certain additional steps of Applicants' method.

### DETAILED DESCRIPTION OF THE PREFERRED EMBODIMENTS

This invention is described in preferred embodiments in the following description with reference to the Figures, in which like numbers represent the same or similar elements. The invention will be described as embodied in a data processing system comprising an information storage and retrieval system in communication with one or more host computers. The following description of Applicants' method is not meant, however, to limit Applicants' invention to data processing systems, as the invention herein can be generally applied to adjusting one or more I/O parameters for bidirectionally exchanging data between one or more computing devices and one or more information storage devices.

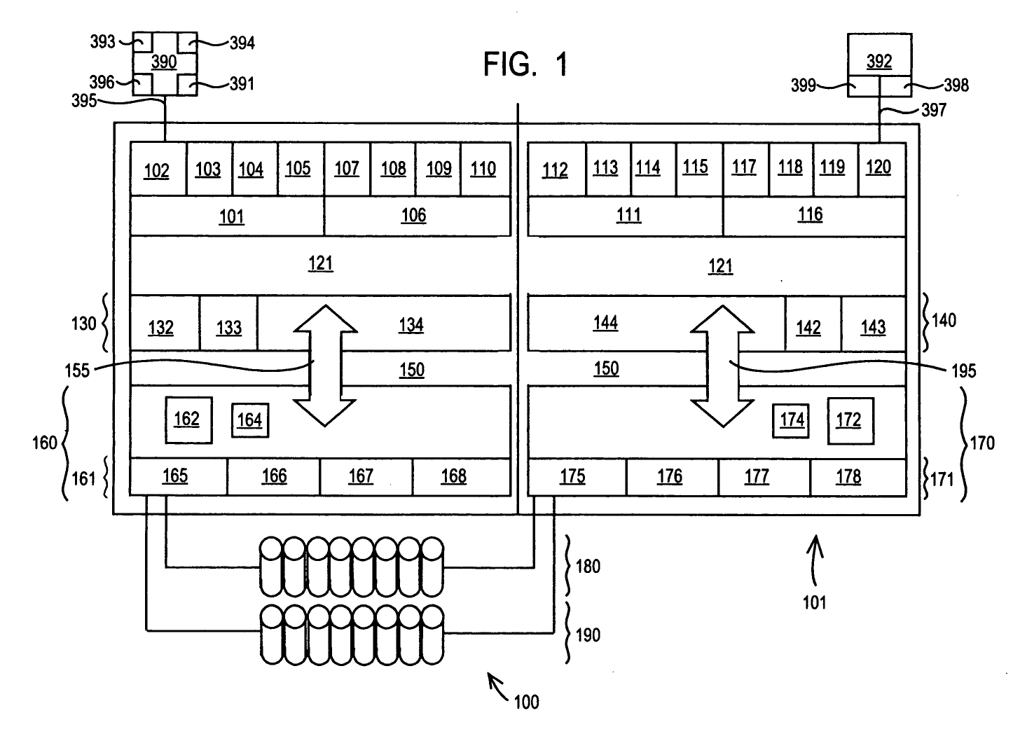

In the illustrated embodiment of FIG. 1, system 100 comprises host computer 390 and information storage and retrieval system 101 which is capable of communication with host computer 390 via communication link 395. The illustrated embodiment of FIG. 1 shows a single host computer. In other embodiments, Applicants' information storage and retrieval system is capable of communicating with a plurality of host computers.

Host computer 390 comprises a computing device, such as a mainframe computer, personal computer, workstation, and combinations thereof, where that computing device comprises an operating system 393 such as Windows, AIX, UNIX, MVS, Linux, etc. (Windows is a registered trademark of Microsoft Corporation; AIX is a registered trademark and MVS is a trademark of IBM Corporation; UNIX is a registered trademark in the United States and other countries licensed exclusively through The Open Group; and Linux is a registered trademark of Linus Torvald). In certain embodiments, operating system 393 comprises one or more device drivers for one or more data storage devices in communication with host computer 390.

Host computer 390 further comprises processor 394. In certain embodiments, host computer 390 further includes a storage management program 391. The storage management program in the host computer 390 may include the functionality of storage management type programs known in the art that manage the transfer of data to and from a information storage and retrieval system, such as the IBM DFSMS implemented in the IBM MVS operating system.

In certain embodiments, Applicants' information storage and retrieval system includes a plurality of host adapters. In the illustrated embodiment of FIG. 1, system 100 comprises host adapters 102-105, 107-110, 112-115 and 117-120. In other embodiments, Applicants' information storage and retrieval system includes fewer than 16 host adapters. In still other embodiments, Applicants' information storage and retrieval system includes more than 16 host adapters. In certain embodiments, one or more of the host adapters are multi-ported. Regardless of the number of host adapters disposed in any embodiments of Applicants' system, each of those host adapters comprises a shared resource that has equal access to both central processing/cache elements 130 and 140.

Each host adapter may comprise one or more Fibre Channel ports, one or more FICON ports, one or more ESCON ports, or one or more SCSI ports, and the like. Each host adapter is connected to both clusters through interconnect bus 121 such that each cluster can handle 1/0 from any host adapter. Internal buses in each subsystem are connected via a Remote 1/0 bridge 155/195 between the processor portions 130/140 and I/O portions 160/170, respectively.

Processor portion 130 includes processor 132 and cache 134. In certain embodiments, processor portion 130 further includes memory 133. In certain embodiments, memory device 133 comprises random access memory. In certain embodiments, memory device 133 comprises non-volatile memory.

Processor portion 140 includes processor 142 and cache 144. In certain embodiments, processor portion 140 further includes memory 143. In certain embodiments, memory device 143 comprises random access memory. In certain embodiments, memory device 143 comprises non-volatile memory.

I/O portion 160 comprises a plurality of device adapters 161 which in the illustrated embodiment of FIG. 1 comprises device adapters 165, 166, 167, and 168. I/O portion 160 further comprise nonvolatile storage (“NVS”) 162 and battery backup 164 for NVS 162.

I/O portion 170 comprises a plurality of device adapters 171 which in the illustrated embodiment of FIG. I comprises device adapters 175, 176, 177, and 178. I/O portion 170 further comprises nonvolatile storage (“NVS”) 172 and battery backup 174 for NVS 172.

In certain embodiments of Applicants' system, one or more host adapters, processor portion 130, and one or more device adapters are disposed on a first control card disposed in Applicants' information storage and retrieval system. Similarly, in certain embodiments, one or more host adapters, processor portion 140, one or more device adapters are disposed on a second control card disposed in Applicants' information storage and retrieval system.

In the illustrated embodiment of FIG. 1, sixteen data storage devices are organized into two arrays, namely array 180 and array 190. The illustrated embodiment of FIG. 1 shows two storage device arrays.

In certain embodiments, one or more of the data storage devices comprise a plurality of hard disk drive units. In certain embodiments, arrays 180 and 190 utilize a RAID protocol. In certain embodiments, arrays 180 and 190 comprise what is sometimes called a JBOD array, i.e. “Just a Bunch Of Disks ” where the array is not configured according to RAID. In certain embodiments, arrays 180 and 190 comprise what is sometimes called an SBOD array, i.e. “Switched Bunch Of Disks”.

The illustrated embodiment of FIG. 1 shows two storage device arrays. In other embodiments, Applicants' system includes a single storage device array. In yet other embodiments, Applicants' system includes more than two storage device arrays.

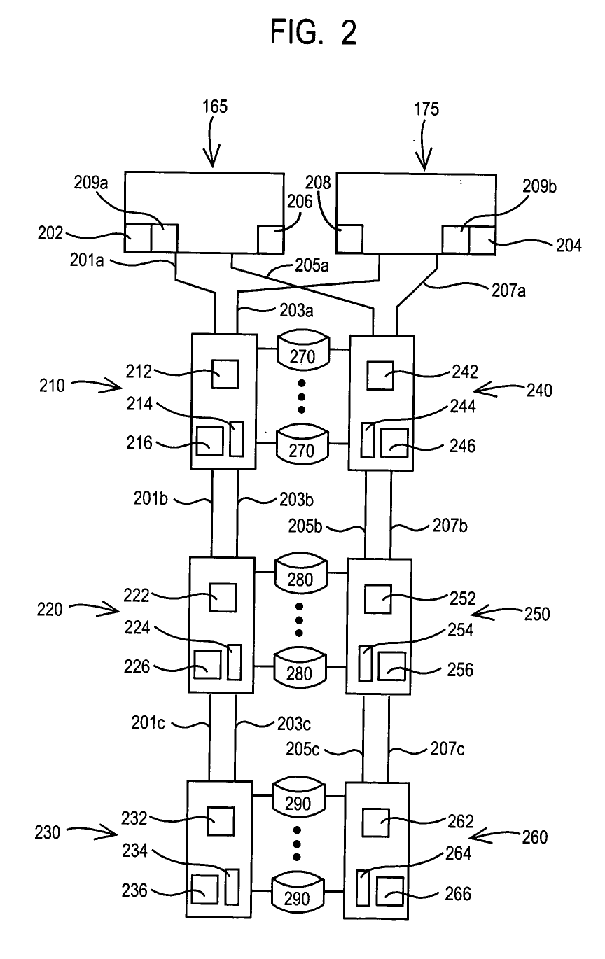

In the illustrated embodiment of FIG. 2, Applicants' information storage and retrieval system comprises dual fibre channel arbitrated (“FC-AL”) loops of switches where the device adapters 165 (FIGS. 1, 2) and 175 (FIGS. 1, 2) are interconnected with two FC-AL loops. In the illustrated embodiment of FIG. 2, device adapter 165 comprises microcode 202 and processor 206. In the illustrated embodiment of FIG. 2, device adapter 175 comprises microcode 204 and processor 208.

Each loop contains one or more local controllers, such as switch domain controllers 210, 220, 230, 240, 250, and 260. Each switch domain controller comprises a switch, a processor, and microcode. In certain embodiments, the switch comprises a Fibre Channel switch. In certain embodiments, the processor comprises a SES processor. For example, local controllers 210, 220, 230, 240, 250, and 260, include processors 212, 222, 232, 242, 252, and 262, respectively. Similarly, local controllers 210, 220, 230, 240, 250, and 260, include switches 214, 224, 234, 244, 254, and 264, respectively. In addition, local controllers 210, 220, 230, 240, 250, and 260, include microcode 216, 226, 236, 246, 256, and 266, respectively.

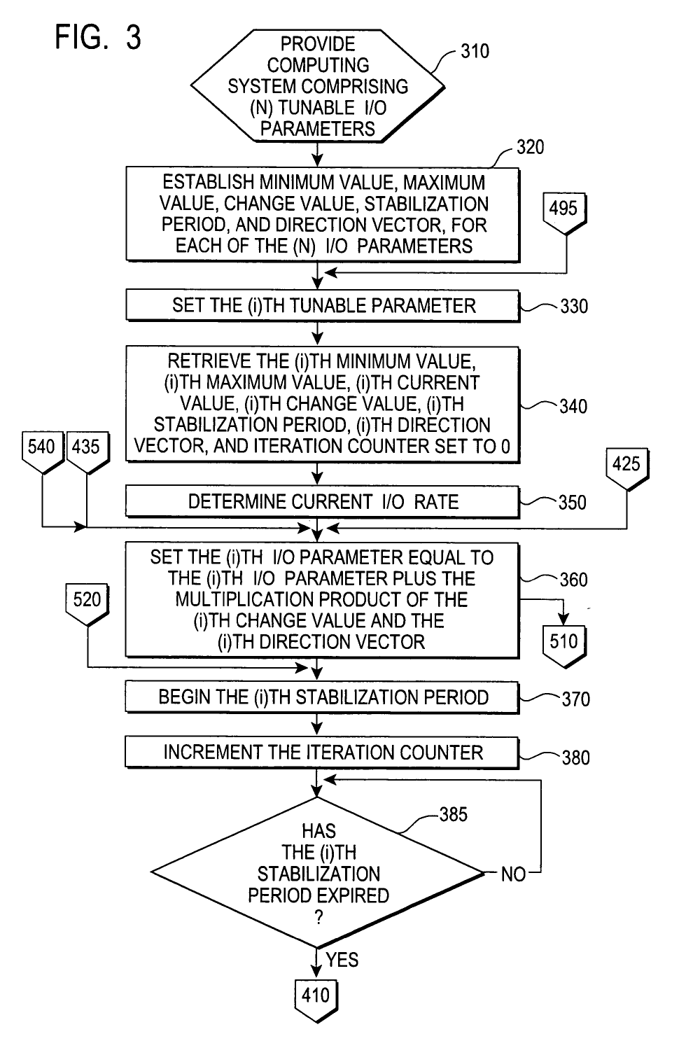

Applicants' invention comprises a method to adjust one or more I/O parameters for a computing system. By “computing system,” Applicants' mean at least one computing device in bidirectional communication with one or more data storage devices. FIG. 3 summarizes the initial steps of Applicants' method.

Referring now to FIG. 3, in step 310 Applicants' method provides a computing system comprising at least one computing device capable of bidirectional communication with one or more data storage devices. In certain embodiments, Applicants' computing system comprises a data processing system, such as system 100 (FIG. 1). Applicants' computing system comprises (N) tunable, i.e. variable, I/O parameters, where (N) is greater than 0. In certain embodiments, one such variable I/O parameter comprises the number of blocks of data to transfer in a single write and/or read operation, such as for example a BLOCKS_PER_IO parameter. In certain embodiments, another such variable I/O parameter comprises the number of outstanding I/O commands that can exist at any given time, such as for example an FCP_SCSI_QUEUE_DEPTH parameter. In certain embodiments, another such variable I/O parameter comprises the number of threads for a certain device, such as for example the number of active threads in device adapter 165 (FIGS. 1, 2).

In step 320, Applicants' method establishes a maximum value, a minimum value, a start value, a change value, a direction vector, and a stabilization period for each of the one or more variable I/O parameters. Table I recites these values for the variable I/O parameters described above.

TABLE I

| | | | | | | STABILI- |
|---|---|---|---|---|---|---|
| | | | | | DIREC- | ZATION |
| Param- | | | | CHANGE | TION | PERIOD |
| eter | MIN | MAX | START | VALUE | VECTOR | (sec) |
| Blocks | 1 | 65535 | 256 | 5 | +1 | 30 |
| per I/O | | | | | | |
| Queue | 1 | 256 | 5 | 1 | +1 | 30 |
| Depth | | | | | | |
| Thread | 1 | 64 | 1 | 1 | +1 | 60 |
| Count | | | | | | |

In certain embodiments, one or more of the values recited in Table 1 are established by the manufacturer of the computing device, such as computer 390. In certain embodiments, one or more of the values recited in Table 1 are established by the manufacturer of the information storage and retrieval system. In certain embodiments, one or more of the values recited in Table 1 are established by the owner of the information storage and retrieval system. In certain embodiments, one or more of the values recited in Table 1 are established by the operator of the information storage and retrieval system. In certain embodiments, one or more of the values recited in Table 1 are established during the initial startup of the information storage and retrieval system. In certain embodiments, one or more of the values recited in Table 1 are established by one or more host computers in communication with the information storage and retrieval system.

In certain embodiments, one or more of the parameters established in step 320 are stored in memory, such as for example memory 396, disposed a computing device, such as host computer 390. In certain embodiments, one or more of the parameters established in step 320 are stored in memory, such as for example memory 133 (FIG. 1) and/or memory 143 (FIG. 1), disposed in an information storage and retrieval system. In certain embodiments, one or more of the parameters established in step 320 are stored in memory, such as for example memory 209a (FIG. 2) and/or memory 209b (FIG. 2), disposed in a device adapter disposed in the information storage and retrieval system. In certain embodiments, one or more of the parameters established in step 320 are written to device microcode, such as microcode 216 (FIG. 2), 226 (FIG. 2), 236 (FIG. 2), 246 (FIG. 2), 256 (FIG. 2), 266 (FIG. 2).

In step 330, Applicants' method selects the (i)th I/O parameter, where that (i)th I/O parameter is one of the one or more I/O parameters of step 310. In certain embodiments, step 330 is performed by a processor, such as processor 394, disposed in a computing device, such as computing device 390. In certain embodiments, step 330 is performed by a processor, such as processor 394, disposed in a computing device using a device driver disposed in an operating system, such as operating system 393 (FIG. 1).

In certain embodiments, step 330 is performed by a host computer in communication with the information storage and retrieval system. In certain embodiments, step 330 is performed by a processor, such as processor 132 (FIG. 1), disposed in the information storage and retrieval system. In certain embodiments, step 330 is performed by a processor, such as processor 206 (FIG. 2), disposed in a device adapter, such as device adapter 165 (FIGS. 1, 2). In certain embodiments, step 330 is performed by a processor disposed in a switch domain, such as for example switch domain processor 212.

In certain embodiments, step 330 is performed by a processor, such as processor 398, disposed in an appliance, such as appliance 392, external to information storage and retrieval system 100, wherein that appliance is in bidirectional communication with system 100, using for example communication link 397. In certain embodiments, appliance 392 comprises a portable device used to adjust the I/O parameters of an information storage and retrieval system, such as system 100.

In step 340, Applicants' method retrieves the (i)th current value, i.e. the current value for the (i)th I/O parameter, the (i)th minimum value, the (i)th maximum value, the (i)th change value, the (i)th stabilization period, the (i)th director vector, and an iteration counter set to 0.

In certain embodiments, step 340 is performed by a processor, such as processor 394, disposed in a computing device, such as computing device 390. In certain embodiments, step 340 is performed by a processor, such as processor 394, disposed in a computing device using a device driver disposed in an operating system, such as operating system 393 (FIG. 1).

In certain embodiments, step 340 is performed by a host computer in communication with the information storage and retrieval system. In certain embodiments, step 340 is performed by a processor, such as processor 132 (FIG. 1), disposed in the information storage and retrieval system. In certain embodiments, step 340 is performed by a processor, such as processor 206 (FIG. 2), disposed in a device adapter, such as device adapter 165 (FIGS. 1, 2). In certain embodiments, step 340 is performed by a processor disposed in a switch domain, such as for example switch domain processor 212. In certain embodiments, step 340 is performed by a processor, such as processor 398, disposed in an appliance, such as appliance 392, external to information storage and retrieval system 100.

Applicants' method transitions from step 340 to step 350 wherein the method determines the current I/O rate for the information storage and retrieval system, such as system 100. In certain embodiments, step 350 is performed by a processor, such as processor 394, disposed in a computing device, such as computing device 390. In certain embodiments, step 350 is performed by a processor, such as processor 394, disposed in a computing device using a device driver disposed in an operating system, such as operating system 393 (FIG. 1).

In certain embodiments, step 350 is performed by a host computer in communication with the information storage and retrieval system. In certain embodiments, step 350 is performed by a processor, such as processor 132 (FIG. 1), disposed in the information storage and retrieval system. In certain embodiments, step 350 is performed by a processor, such as processor 206 (FIG. 2), disposed in a device adapter, such as device adapter 165 (FIGS. 1, 2). In certain embodiments, step 350 is performed by a processor disposed in a switch domain, such as for example switch domain processor 212. In certain embodiments, step 350 is performed by a processor, such as processor 398, disposed in an appliance, such as appliance 392, external to information storage and retrieval system 100.

Applicants' method transitions from step 350 to step 360 wherein the method calculates an adjusted (i)th I/O parameter by setting the (i)th I/O parameter to the (i)th I/O current value of step 340 plus the multiplication product of the (i)th change value and the (i)th direction vector. In certain embodiments, step 360 is performed by a processor, such as processor 394, disposed in a computing device, such as computing device 390. In certain embodiments, step 360 is performed by a processor, such as processor 394, disposed in a computing device using a device driver disposed in an operating system, such as operating system 393 (FIG. 1).

In certain embodiments, step 360 is performed by a host computer in communication with the information storage and retrieval system. In certain embodiments, step 360 is performed by a processor, such as processor 132 (FIG. 1), disposed in the information storage and retrieval system. In certain embodiments, step 360 is performed by a processor, such as processor 206 (FIG. 2), disposed in a device adapter, such as device adapter 165 (FIGS. 1, 2). In certain embodiments, step 360 is performed by a processor disposed in a switch domain, such as for example switch domain processor 212. In certain embodiments, step 360 is performed by a processor, such as processor 398, disposed in an appliance, such as appliance 392, external to information storage and retrieval system 100.

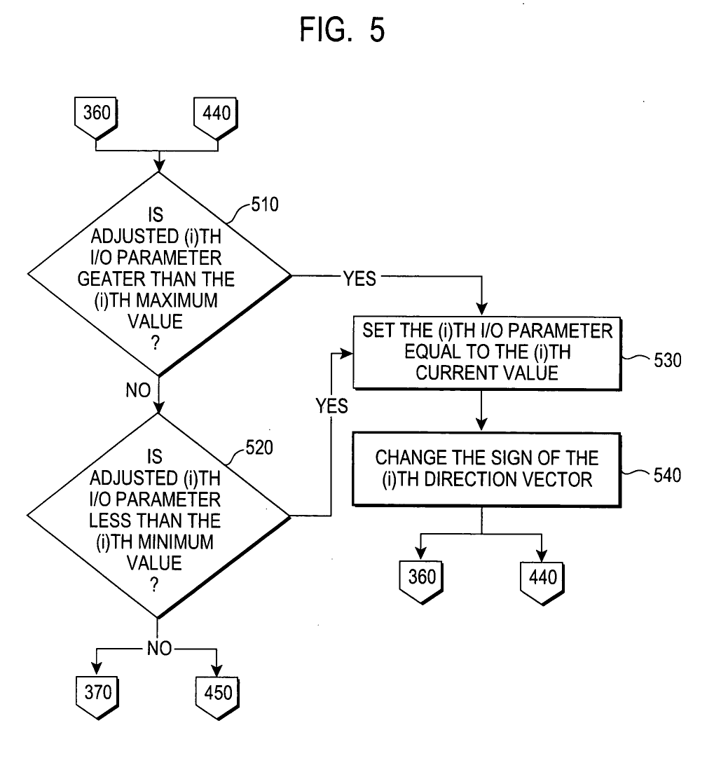

In certain embodiments, Applicants' method transitions from step 360 to step 370. In other embodiments, Applicants' method transitions from step 360 to step 510 (FIG. 5) wherein Applicants' method determines if the adjusted (i)th I/O parameter is greater than the (i)th maximum value. In certain embodiments, step 510 is performed by a processor, such as processor 394, disposed in a computing device, such as computing device 390. In certain embodiments, step 510 is performed by a processor, such as processor 394, disposed in a computing device using a device driver disposed in an operating system, such as operating system 393 (FIG. 1).

In certain embodiments, step 510 is performed by a host computer in communication with the information storage and retrieval system. In certain embodiments, step 510 is performed by a processor, such as processor 132 (FIG. 1), disposed in the information storage and retrieval system. In certain embodiments, step 510 is performed by a processor, such as processor 206 (FIG. 2), disposed in a device adapter, such as device adapter 165 (FIGS. 1, 2). In certain embodiments, step 510 is performed by a processor disposed in a switch domain, such as for example switch domain processor 212. In certain embodiments, step 510 is performed by a processor, such as processor 398, disposed in an appliance, such as appliance 392, external to information storage and retrieval system 100.

If Applicants' method determines in step 510 that the adjusted (i)th I/O parameter is greater than the(i)th maximum value, then the method transitions from step 510 to step 530 wherein the method sets the (i)th I/O parameter equal to the (i)th current value. In certain embodiments, step 530 is performed by a processor, such as processor 394, disposed in a computing device, such as computing device 390. In certain embodiments, step 530 is performed by a processor, such as processor 394, disposed in a computing device using a device driver disposed in an operating system, such as operating system 393 (FIG. 1).

In certain embodiments, step 530 is performed by a host computer in communication with the information storage and retrieval system. In certain embodiments, step 530 is performed by a processor, such as processor 132 (FIG. 1), disposed in the information storage and retrieval system. In certain embodiments, step 530 is performed by a processor, such as processor 206 (FIG. 2), disposed in a device adapter, such as device adapter 165 (FIGS. 1, 2). In certain embodiments, step 530 is performed by a processor disposed in a switch domain, such as for example switch domain processor 212. In certain embodiments, step 530 is performed by a processor, such as processor 398, disposed in an appliance, such as appliance 392, external to information storage and retrieval system 100.

Applicants' method transitions from step 530 to step 540 wherein the method changes the sign of the (i)th direction vector. In certain embodiments, step 540 is performed by a processor, such as processor 394, disposed in a computing device, such as computing device 390. In certain embodiments, step 540 is performed by a processor, such as processor 394, disposed in a computing device using a device driver disposed in an operating system, such as operating system 393 (FIG. 1).

In certain embodiments, step 540 is performed by a host computer in communication with the information storage and retrieval system. In certain embodiments, step 540 is performed by a processor, such as processor 132 (FIG. 1), disposed in the information storage and retrieval system. In certain embodiments, step 540 is performed by a processor, such as processor 206 (FIG. 2), disposed in a device adapter, such as device adapter 165 (FIGS. 1, 2). In certain embodiments, step 540 is performed by a processor disposed in a switch domain, such as for example switch domain processor 212. In certain embodiments, step 540 is performed by a processor, such as processor 398, disposed in an appliance, such as appliance 392, external to information storage and retrieval system 100.

If Applicants' method transitioned from step 360 to step 510 then the method transitions from step 540 to step 360 and continues as described herein. If Applicants' method transitioned from step 440 to step 510 then the method transitions from step 540 to step 440 and continues as described herein.

If Applicants' method determines in step 510 that the adjusted (i)th I/O parameter is not greater than the(i)th maximum value, then the method transitions from step 510 to step 520 wherein the method determines if the adjusted (i)th I/O parameter is less than the (i)th minimum value. In certain embodiments, step 520 is performed by a processor, such as processor 394, disposed in a computing device using a device driver disposed in an operating system, such as operating system 393 (FIG. 1).

In certain embodiments, step 520 is performed by a host computer in communication with the information storage and retrieval system. In certain embodiments, step 520 is performed by a processor, such as processor 132 (FIG. 1), disposed in the information storage and retrieval system. In certain embodiments, step 520 is performed by a processor, such as processor 206 (FIG. 2), disposed in a device adapter, such as device adapter 165 (FIGS. 1, 2). In certain embodiments, step 520 is performed by a processor disposed in a switch domain, such as for example switch domain processor 212. In certain embodiments, step 520 is performed by a processor, such as processor 398, disposed in an appliance, such as appliance 392, external to information storage and retrieval system 100.

If Applicants' method determines in step 520 that the adjusted (i)th I/O parameter is less than the(i)th minimum value, then the method transitions from step 520 to step 530 and continues as described herein. If Applicants' method determines in step 520 that the adjusted (i)th I/O parameter is not less than the(i)th minimum value, and if the method transitioned from step 360 to step 510 then the method transitions from step 520 to step 370 and continues as described herein. If Applicants' method determines in step 520 that the adjusted (i)th I/O parameter is not less than the(i)th minimum value, and if the method transitioned from step 440 to step 510 then the method transitions from step 520 to step 450 and continues as described herein.

Referring once again to FIG. 3, in step 370 Applicants' method begins the (i)th stabilization period. In certain embodiments, step 370 is performed by a processor, such as processor 394, disposed in a computing device, such as computing device 390. In certain embodiments, step 370 is performed by a processor, such as processor 394, disposed in a computing device using a device driver disposed in an operating system, such as operating system 393 (FIG. 1).

In certain embodiments, step 370 is performed by a host computer in communication with the information storage and retrieval system. In certain embodiments, step 370 is performed by a processor, such as processor 132 (FIG. 1), disposed in the information storage and retrieval system. In certain embodiments, step 370 is performed by a processor, such as processor 206 (FIG. 2), disposed in a device adapter, such as device adapter 165 (FIGS. 1, 2). In certain embodiments, step 370 is performed by a processor disposed in a switch domain, such as for example switch domain processor 212. In certain embodiments, step 370 is performed by a processor, such as processor 398, disposed in an appliance, such as appliance 392, external to information storage and retrieval system 100.

In step 380, Applicants' method increments by unity the iteration counter. In certain embodiments, step 380 is performed during the (i)th stabilization period. In certain embodiments, steps 370 and 380 are performed substantially synchronously. In certain embodiments, step 380 is performed by a processor, such as processor 394, disposed in a computing device, such as computing device 390. In certain embodiments, step 380 is performed by a processor, such as processor 394, disposed in a computing device using a device driver disposed in an operating system, such as operating system 393 (FIG. 1).

In certain embodiments, step 380 is performed by a host computer in communication with the information storage and retrieval system. In certain embodiments, step 380 is performed by a processor, such as processor 132 (FIG. 1), disposed in the information storage and retrieval system. In certain embodiments, step 380 is performed by a processor, such as processor 206 (FIG. 2), disposed in a device adapter, such as device adapter 165 (FIGS. 1, 2). In certain embodiments, step 380 is performed by a processor disposed in a switch domain, such as for example switch domain processor 212. In certain embodiments, step 380 is performed by a processor, such as processor 398, disposed in an appliance, such as appliance 392, external to information storage and retrieval system 100.

In step 385, Applicants' method determines if the (i)th stabilization period has expired. In certain embodiments, step 385 is performed by a processor, such as processor 394, disposed in a computing device, such as computing device 390. In certain embodiments, step 385 is performed by a processor, such as processor 394, disposed in a computing device using a device driver disposed in an operating system, such as operating system 393 (FIG. 1).

In certain embodiments, step 385 is performed by a host computer in communication with the information storage and retrieval system. In certain embodiments, step 385 is performed by a processor, such as processor 132 (FIG. 1), disposed in the information storage and retrieval system. In certain embodiments, step 385 is performed by a processor, such as processor 206 (FIG. 2), disposed in a device adapter, such as device adapter 165 (FIGS. 1, 2). In certain embodiments, step 385 is performed by a processor disposed in a switch domain, such as for example switch domain processor 212. In certain embodiments, step 385 is performed by a processor, such as processor 398, disposed in an appliance, such as appliance 392, external to information storage and retrieval system 100.

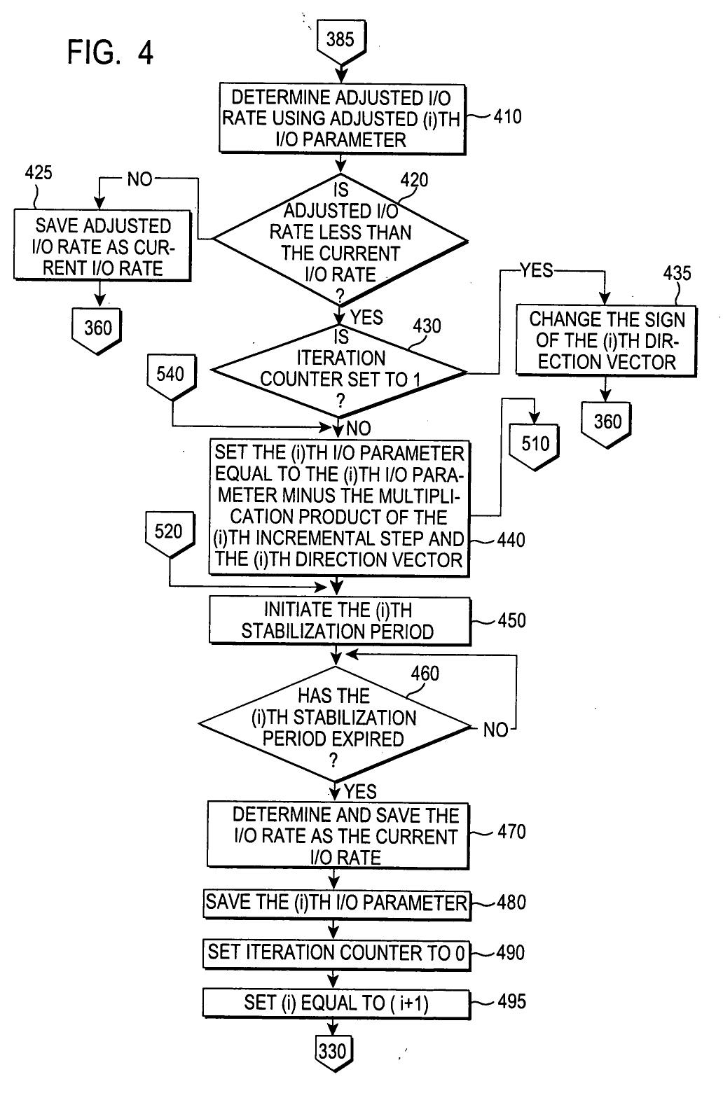

If Applicants' method determines in step 385 that the (i)th stabilization period, initiated in step 370, has not yet expired, then the method continues to monitor whether the (i)th stabilization period has expired. Alternatively, if the method determines in step 385 that the (i)th stabilization period has expired, then the method transitions from step 385 to step 410 (FIG. 4).

Referring now to FIG. 4, in step 410 Applicants' method determines an adjusted I/O rate realized using the adjusted (i)th I/O parameter. In certain embodiments, step 410 is performed by a processor, such as processor 394, disposed in a computing device, such as computing device 390. In certain embodiments, step 410 is performed by a processor, such as processor 394, disposed in a computing device using a device driver disposed in an operating system, such as operating system 393 (FIG. 1).

In certain embodiments, step 410 is performed by a host computer in communication with the information storage and retrieval system. In certain embodiments, step 410 is performed by a processor, such as processor 132 (FIG. 1), disposed in the information storage and retrieval system. In certain embodiments, step 410 is performed by a processor, such as processor 206 (FIG. 2), disposed in a device adapter, such as device adapter 165 (FIGS. 1, 2). In certain embodiments, step 410 is performed by a processor disposed in a switch domain, such as for example switch domain processor 212. In certain embodiments, step 410 is performed by a processor, such as processor 398, disposed in an appliance, such as appliance 392, external to information storage and retrieval system 100.

Applicants' method transitions from step 410 to step 420 wherein the method determines if the adjusted I/O rate determined in step 410 is less than the current I/O rate determined in step 350 (FIG. 3), step 470 (FIG. 4), or step 425 (FIG. 4). In certain embodiments, step 420 is performed by a processor, such as processor 394, disposed in a computing device, such as computing device 390. In certain embodiments, step 420 is performed by a processor, such as processor 394, disposed in a computing device using a device driver disposed in an operating system, such as operating system 393 (FIG. 1).

In certain embodiments, step 420 is performed by a host computer in communication with the information storage and retrieval system. In certain embodiments, step 420 is performed by a processor, such as processor 132 (FIG. 1), disposed in the information storage and retrieval system. In certain embodiments, step 420 is performed by a processor, such as processor 206 (FIG. 2), disposed in a device adapter, such as device adapter 165 (FIGS. 1, 2). In certain embodiments, step 420 is performed by a processor disposed in a switch domain, such as for example switch domain processor 212. In certain embodiments, step 420 is performed by a processor, such as processor 398, disposed in an appliance, such as appliance 392, external to information storage and retrieval system 100.

If Applicants' method determines that the I/O rate of step 410 is not less than the current I/O rate determined in step 350, 470, or 425, then the method transitions from step 420 to step 425 wherein the method saves the I/O rate determined in step 410 as the current I/O rate. In certain embodiments, step 425 is performed by a processor, such as processor 394, disposed in a computing device, such as computing device 390. In certain embodiments, step 425 is performed by a processor, such as processor 394, disposed in a computing device using a device driver disposed in an operating system, such as operating system 393 (FIG. 1).

In certain embodiments, step 425 is performed by a host computer in communication with the information storage and retrieval system. In certain embodiments, step 425 is performed by a processor, such as processor 132 (FIG. 1), disposed in the information storage and retrieval system. In certain embodiments, step 425 is performed by a processor, such as processor 206 (FIG. 2), disposed in a device adapter, such as device adapter 165 (FIGS. 1, 2). In certain embodiments, step 425 is performed by a processor disposed in a switch domain, such as for example switch domain processor 212. In certain embodiments, step 425 is performed by a processor, such as processor 398, disposed in an appliance, such as appliance 392, external to information storage and retrieval system 100. Applicants' method transitions from step 425 to step 360 and continues as described herein.

If Applicants' method determines in step 420 that the I/O rate determined in step 410 is less than the I/O rate determined in step 350 (FIG. 3), 470 (FIG. 4), or 425 (FIG. 4), then the method transitions from step 420 to step 430 wherein the method determines if the iteration counter is set to 1. In certain embodiments, step 430 is performed by a processor, such as processor 394, disposed in a computing device, such as computing device 390. In certain embodiments, step 430 is performed by a processor, such as processor 394, disposed in a computing device using a device driver disposed in an operating system, such as operating system 393 (FIG. 1).

In certain embodiments, step 430 is performed by a host computer in communication with the information storage and retrieval system. In certain embodiments, step 430 is performed by a processor, such as processor 132 (FIG. 1), disposed in the information storage and retrieval system. In certain embodiments, step 430 is performed by a processor, such as processor 206 (FIG. 2), disposed in a device adapter, such as device adapter 165 (FIGS. 1, 2). In certain embodiments, step 430 is performed by a processor disposed in a switch domain, such as for example switch domain processor 212. In certain embodiments, step 430 is performed by a processor, such as processor 398, disposed in an appliance, such as appliance 392, external to information storage and retrieval system 100.

If Applicants' method determines in step 430 that the iteration counter is set to 1, then the method transitions from step 430 to step 435 wherein the method changes the sign of the (i)th direction vector, i.e. in step 435 the method sets the (i)th direction vector equal to the multiplication product of the (i)th direction vector of step 340 and −1. In certain embodiments, step 435 is performed by a processor, such as processor 394, disposed in a computing device, such as computing device 390. In certain embodiments, step 435 is performed by a processor, such as processor 394, disposed in a computing device using a device driver disposed in an operating system, such as operating system 393 (FIG. 1).

In certain embodiments, step 435 is performed by a host computer in communication with the information storage and retrieval system. In certain embodiments, step 435 is performed by a processor, such as processor 132 (FIG. 1), disposed in the information storage and retrieval system. In certain embodiments, step 435 is performed by a processor, such as processor 206 (FIG. 2), disposed in a device adapter, such as device adapter 165 (FIGS. 1, 2). In certain embodiments, step 435 is performed by a processor disposed in a switch domain, such as for example switch domain processor 212. In certain embodiments, step 435 is performed by a processor, such as processor 398, disposed in an appliance, such as appliance 392, external to information storage and retrieval system 100. Applicants' method transitions from step 435 to step 360 and continues as described herein.

If Applicants' method determines in step 430 that the iteration counter is not set to 1, then the method transitions from step 430 to step 440 wherein the method sets the (i)th I/O parameter equal to the (i)th current value retrieved in step 340, i.e. reverses the action taken in step 360. In certain embodiments, step 440 comprises setting the (i)th I/O parameter equal to the adjusted value of step 360 minus the multiplication product of the (i)th change value and the (i)th direction vector. In certain embodiments, step 440 is performed by a processor, such as processor 394, disposed in a computing device, such as computing device 390. In certain embodiments, step 440 is performed by a processor, such as processor 394, disposed in a computing device using a device driver disposed in an operating system, such as operating system 393 (FIG. 1).

In certain embodiments, step 440 is performed by a host computer in communication with the information storage and retrieval system. In certain embodiments, step 440 is performed by a processor, such as processor 132 (FIG. 1), disposed in the information storage and retrieval system. In certain embodiments, step 440 is performed by a processor, such as processor 206 (FIG. 2), disposed in a device adapter, such as device adapter 165 (FIGS. 1, 2). In certain embodiments, step 440 is performed by a processor disposed in a switch domain, such as for example switch domain processor 212. In certain embodiments, step 440 is performed by a processor, such as processor 398, disposed in an appliance, such as appliance 392, external to information storage and retrieval system 100.

In certain embodiments, Applicants' method transitions from step 440 to step 510 and continues as described herein. In other embodiments, Applicants' method transitions from step 440 to step 450. In step 450, Applicants' method implements, i.e. begins, the (i)th stabilization period. In certain embodiments, step 450 is performed by a processor, such as processor 394, disposed in a computing device, such as computing device 390. In certain embodiments, step 450 is performed by a processor, such as processor 394, disposed in a computing device using a device driver disposed in an operating system, such as operating system 393 (FIG. 1).

In certain embodiments, step 450 is performed by a host computer in communication with the information storage and retrieval system. In certain embodiments, step 450 is performed by a processor, such as processor 132 (FIG. 1), disposed in the information storage and retrieval system. In certain embodiments, step 450 is performed by a processor, such as processor 206 (FIG. 2), disposed in a device adapter, such as device adapter 165 (FIGS. 1, 2). In certain embodiments, step 450 is performed by a processor disposed in a switch domain, such as for example switch domain processor 212. In certain embodiments, step 450 is performed by a processor, such as processor 398, disposed in an appliance, such as appliance 392, external to information storage and retrieval system 100.

Applicants' method transitions from step 450 to step 460 wherein Applicants' method determines if the (i)th stabilization period has expired. In certain embodiments, step 460 is performed by a processor, such as processor 394, disposed in a computing device, such as computing device 390. In certain embodiments, step 460 is performed by a processor, such as processor 394, disposed in a computing device using a device driver disposed in an operating system, such as operating system 393 (FIG. 1).

In certain embodiments, step 460 is performed by a host computer in communication, with the information storage and retrieval system. In certain embodiments, step 460 is performed by a processor, such as processor 132 (FIG. 1), disposed in the information storage and retrieval system. In certain embodiments, step 460 is performed by a processor, such as processor 206 (FIG. 2), disposed in a device adapter, such as device adapter 165 (FIGS. 1, 2). In certain embodiments, step 460 is performed by a processor disposed in a switch domain, such as for example switch domain processor 212. In certain embodiments, step 460 is performed by a processor, such as processor 398, disposed in an appliance, such as appliance 392, external to information storage and retrieval system 100.

If Applicants' method determines in step 460 that the (i)th stabilization period, initiated in step 450, has not yet expired, then the method continues to monitor whether the (i)th stabilization period has expired. Alternatively, if the method determines in step 460 that the (i)th stabilization period has expired, then the method transitions from step 460 to step 470 wherein the method determines the system's I/O rate, and saves that I/O rate as the current I/O rate. In certain embodiments, step 470 is performed by a processor, such as processor 394, disposed in a computing device, such as computing device 390. In certain embodiments, step 470 is performed by a processor, such as processor 394, disposed in a computing device using a device driver disposed in an operating system, such as operating system 393 (FIG. 1).

In certain embodiments, step 470 is performed by a host computer in communication with the information storage and retrieval system. In certain embodiments, step 470 is performed by a processor, such as processor 132 (FIG. 1), disposed in the information storage and retrieval system. In certain embodiments, step 470 is performed by a processor, such as processor 206 (FIG. 2), disposed in a device adapter, such as device adapter 165 (FIGS. 1, 2). In certain embodiments, step 470 is performed by a processor disposed in a switch domain, such as for example switch domain processor 212. In certain embodiments, step 470 is performed by a processor, such as processor 398, disposed in an appliance, such as appliance 392, external to information storage and retrieval system 100.

Applicants' method transitions from step 470 to step 480 wherein the method saves the value of (i)th I/O parameter set in step 440 as the (i)th current value. In certain embodiments, step 480 is performed by a processor, such as processor 394, disposed in a computing device, such as computing device 390. In certain embodiments, step 480 is performed by a processor, such as processor 394, disposed in a computing device using a device driver disposed in an operating system, such as operating system 393 (FIG. 1).

In certain embodiments, step 480 is performed by a host computer in communication with the information storage and retrieval system. In certain embodiments, step 480 is performed by a processor, such as processor 132 (FIG. 1), disposed in the information storage and retrieval system. In certain embodiments, step 480 is performed by a processor, such as processor 206 (FIG. 2), disposed in a device adapter, such as device adapter 165 (FIGS. 1, 2). In certain embodiments, step 480 is performed by a processor disposed in a switch domain, such as for example switch domain processor 212. In certain embodiments, step 480 is performed by a processor, such as processor 398, disposed in an appliance, such as appliance 392, external to information storage and retrieval system 100.

Applicants' method transitions from step 480 to step 490 wherein the method sets the iteration counter to 0. In certain embodiments, step 490 is performed by a processor, such as processor 394, disposed in a computing device, such as computing device 390. In certain embodiments, step 490 is performed by a processor, such as processor 394, disposed in a computing device using a device driver disposed in an operating system, such as operating system 393 (FIG. 1).

In certain embodiments, step 490 is performed by a host computer in communication with the information storage and retrieval system. In certain embodiments, step 490 is performed by a processor, such as processor 132 (FIG. 1), disposed in the information storage and retrieval system. In certain embodiments, step 490 is performed by a processor, such as processor 206 (FIG. 2), disposed in a device adapter, such as device adapter 165 (FIGS. 1, 2). In certain embodiments, step 490 is performed by a processor disposed in a switch domain, such as for example switch domain processor 212. In certain embodiments, step 490 is performed by a processor, such as processor 398, disposed in an appliance, such as appliance 392, external to information storage and retrieval system 100.

Applicants' method transitions from step 490 to step 495 wherein the method increments (i) by unity, i.e. sets (i) equal to (i+1). In certain embodiments, step 495 is performed by a processor, such as processor 394, disposed in a computing device, such as computing device 390. In certain embodiments, step 495 is performed by a processor, such as processor 394, disposed in a computing device using a device driver disposed in an operating system, such as operating system 393 (FIG. 1).

In certain embodiments, step 495 is performed by a host computer in communication with the information storage and retrieval system. In certain embodiments, step 495 is performed by a processor, such as processor 132 (FIG. 1), disposed in the information storage and retrieval system. In certain embodiments, step 495 is performed by a processor, such as processor 206 (FIG. 2), disposed in a device adapter, such as device adapter 165 (FIGS. 1, 2). In certain embodiments, step 495 is performed by a processor disposed in a switch domain, such as for example switch domain processor 212. In certain embodiments, step 495 is performed by a processor, such as processor 398, disposed in an appliance, such as appliance 392, external to information storage and retrieval system 100. Applicants' method transitions from step 495 to step 330 (FIG. 3) and continues as described herein.

The following examples are presented to further illustrate to persons skilled in the art how to make and use the invention. These examples are not intended as a limitation, however, upon the scope of the invention, which is defined only by the appended claims.

### EXAMPLE 1

In step 330, a computing device, such as host computer 390 (FIG. 1), selects the I/O parameter BLOCKS_PER_IO, i.e. the (i)th I/O parameter, and calls a processor, such as processor 206 (FIG. 2), disposed in a device adapter, such as device adapter 165, disposed in the information storage and retrieval system, to optimize that selected I/O parameter.

The device adapter in step 340 retrieves data pertinent to the selected I/O parameter, in step 350 determines the current I/O rate, in step 360 calculates an adjusted (i)th I/O parameter, in step 370 implements the (i)th stabilization period, in step 380 sets the iteration counter to 1, and after expiration of the (i)th stabilization period determines in step 410 an adjusted I/O rate.

As long as an adjusted I/O rate is not less than the prior I/O rate, the device adapter repeats steps 360, 370, 380, 385, 410, 420, and 425. Eventually, raising the number of blocks per I/O results in a negative performance change, i.e. the adjusted I/O rate is less than the current I/O rate. In response, the device adapter determines in step 430 that the iteration counter is not set to 1, and the device adapter in step 440 sets the (i)th I/O parameter to the current value saved during the previous iteration at step 425, in step 450 implements the (i)th stabilization period, after expiration of that stabilization period in step 470 determines and saves the current I/O rate, in step 480 saves the value of the (i)th I/O parameter set in step 470 as the (i)th current value, and in step 490 sets the iteration counter to 0. The device adapter then provides a signal to the host computer that the selected parameter, i.e. BLOCKS_PER_IO has been optimized.

### EXAMPLE 2

Upon receiving a signal from the device adapter that the I/O parameter BLOCKS_PER_IO has been optimized, the host computer selects the I/O parameter FCP_SCSI_QUEUE_DEPTH, and calls a device driver component of the host computer operating system to optimize that selected I/O parameter. In step 360 the operating system/device driver adjusts the FCP_SCSI_QUEUE_DEPTH parameter by adding the appropriate change value to the current value to permit the simultaneous execution of more commands. In step 420 the operating system/device driver determines that the I/O rate decreased. The current value of the FCP_SCSI_QUEUE_DEPTH parameter is not changed.

In step 430, the operating system/device driver determines that the iteration counter is set to 1, i.e. an initial adjustment had an adverse impact. In step 435, the operating system/device driver changes the sign of the (i)th direction vector, and in step 360 the operating system/device driver adjusts the FCP_SCSI_QUEUE_DEPTH parameter by subtracting the appropriate change value from the current value to permit the simultaneous execution of fewer commands.

In step 420, the operating system/device driver again determines that the system's I/O rate decreased. The current value of the FCP_SCSI_QUEUE_DEPTH parameter is not changed. The operating system/device driver then returns the I/O parameter FCP_SCSI_QUEUE_DEPTH to the current value in step 440.

In certain embodiments, individual steps recited in FIGS. 3 and/or 4 may be combined, eliminated, or reordered.

In certain embodiments, Applicants' invention includes instructions residing in microcode/memory, such as for example microcode 202 (FIG. 2)/204 (FIG. 2), and/or memory 133 (FIG. 1)/143 (FIG. 1), and/or 216 (FIG. 2)/226 (FIG. 2)/236 (FIG. 2)/246 (FIG. 2)/256 (FIG. 2)/266 (FIG. 2), where those instructions are executed by a processor, such as processor 206 (FIG. 2)/208 (FIG. 2), and/or 132/142, and/or 212 (FIG. 2), 222 (FIG. 2), 232 (FIG. 2), 242 (FIG. 2), 252 (FIG. 2), 262 (FIG. 2), respectively, to perform steps 330, 340, 350, 360, 370, 380, 385, recited in FIG. 3, and/or steps 410, 420, 425, 430, 435, 440, 440, 450, 460, 470, 480, and/or 490, recited in FIG. 4, and/or steps 510, 520, 530, and/or 540, recited in FIG. 5.

In other embodiments, Applicants' invention includes instructions residing in any other computer program product, where those instructions are executed by a computer external to, or internal to, system 100, to perform steps 330, 340, 350, 360, 370, 380, 385, recited in FIG. 3, and/or steps 410, 420, 425, 430, 435, 440, 440, 450, 460, 470, 480, and/or 490, recited in FIG. 4, and/or steps 510, 520, 530, and/or 540, recited in FIG. 5. In either case, the instructions may be encoded in an information storage medium comprising, for example, a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method to adjust one or more input/output parameters for a computing system, comprising the steps of:
providing a computing system comprising at least one computing device in bidirectional communication with one or more data storage devices, wherein said computing system comprises one or more variable I/O parameters;
establishing a change value and a stabilization period for each of said one or more I/O parameters;
ascertaining a current I/O rate;
selecting the (i)th I/O parameter, wherein said (i)th I/O parameter is one of said one or more I/O parameters, and wherein said (i)th I/O parameter comprises the (i)th current value;
adjusting the (i)th I/O parameter to equal said (i)th current value plus the (i)th change value;
calculating an adjusted I/O rate;
determining if said adjusted I/O rate is less than said current I/O rate;
operative if said adjusted I/O rate is not less than said current I/O rate, saving said adjusted (i)th I/O parameter as said (i)th current value.

2. The method of claim 1, further comprising the steps of:
establishing a stabilization period for each of said one or more I/O parameters;
implementing the (i)th stabilization period after performing said adjusting step and before performing said calculating step.

3. The method of claim 1, further comprising the steps of repeating said adjusting, calculating, and determining steps if said adjusted I/O rate is less than said current I/O rate.

4. The method of claim 3, further comprising the steps of:
establishing a minimum value and a maximum value for each of said one or more I/O parameters;
ascertaining if said adjusted (i)th I/O parameter is greater than or equal to the (i)th minimum value and less than or equal to the (i)th maximum value;
operative if said adjusted (i)th I/O parameter is not greater than or equal to the (i)th minimum value or less than or equal to the (i)th maximum value, setting said (i)th I/O parameter equal to said current value;
operative if said adjusted (i)th I/O parameter is greater than or equal to the (i)th minimum value, and is less than or equal to the (i)th maximum value, saving said adjusted (i)th I/O parameter as the (i)th current value.

5. The method of claim 4, further comprising the steps of:
providing an iteration counter set to 0;
incrementing said iteration counter after performing said adjusting step and before performing said determining step;
operative if said adjusted I/O rate is less than said current I/O rate, ascertaining if said iteration counter is set to 1;
operative if said iteration counter is not set to 1, setting said (i)th I/O parameter to equal said (i)th adjusted value minus said (i)th change value.

6. The method of claim 5, further comprising the steps of:
operative if said adjusted I/O rate is less than said current I/O rate, and if said iteration counter is not set to 1:
saving said (i)th I/O parameter as said (i)th current value;
setting said iteration counter to 0.

7. The method of claim 5, further comprising the steps of:
establishing a direction vector for each of said one or more I/O parameters, wherein the (i)th direction vector comprises a value and a sign, wherein the (i)th direction vector sign is selected from the group consisting of positive and negative;
wherein said adjusting step comprises adjusting the (i)th I/O parameter to equal said current value plus the multiplication product of said (i)th change value and said (i)th direction vector;
operative if said adjusted I/O rate is less than said current I/O rate and if said iteration counter is set to 1, changing the (i)th direction vector sign, and repeating said adjusting, saving, calculating, and determining steps.

8. An article of manufacture comprising a computer useable medium having computer readable program code disposed therein to adjust one or more input/output parameters for a computing system comprising one or more variable I/O parameters, said article of manufacture further comprising a pre-determined change value for each of said one or more I/O parameters, and a pre-determined stabilization period for each of said one or more I/O parameters, the computer readable program code comprising a series of computer readable program steps to effect:
ascertaining a current I/O rate;
selecting the (i)th I/O parameter, wherein said (i)th I/O parameter is one of said one or more I/O parameters, and wherein said (i)th I/O parameter comprises the (i)th current value;
adjusting the (i)th I/O parameter to equal said current value plus the (i)th change value;
calculating an adjusted I/O rate;
determining if said adjusted I/O rate is less than said current I/O rate;
operative if said adjusted I/O rate is less than said current I/O rate, saving said adjusted (i)th I/O parameter as said (i)th current value.

9. The article of manufacture of claim 8, wherein said article of manufacture further comprises a pre-determined stabilization period for each of said one or more I/O parameters, said computer readable program code further comprising a series of computer readable program steps to effect implementing the (i)th stabilization period after performing said adjusting step and before performing said calculating step.

10. The article of manufacture of claim 8, said computer readable program code further comprising a series of computer readable program steps to effect repeating said adjusting, calculating, and determining steps if said adjusted I/O rate is less than said current I/O rate.

11. The article of manufacture of claim 10, wherein said article of manufacture further comprises a pre-determined minimum value and maximum value for each of said one or more I/O parameters, said computer readable program code further comprising a series of computer readable program steps to effect:
ascertaining if said adjusted (i)th I/O parameter is greater than or equal to the (i)th minimum value and less than or equal to the (i)th maximum value;
operative if said adjusted (i)th I/O parameter is not greater than or equal to the (i)th minimum value or less than or equal to the (i)th maximum value, setting said (i)th I/O parameter equal to said current value;
operative if said adjusted (i)th I/O parameter is greater than or equal to the (i)th minimum value, and is less than or equal to the (i)th maximum value, saving said adjusted (i)th I/O parameter as the (i)th current value.

12. The article of manufacture of claim 11, wherein said article of manufacture further comprises an iteration counter set to 0, said computer readable program code further comprising a series of computer readable program steps to effect:
incrementing said iteration counter after performing said adjusting step and before performing said determining step;
operative if said adjusted I/O rate is not less than said current I/O rate, ascertaining if said iteration counter is set to 1;
operative if said iteration counter is not set to 1, setting said (i)th I/O parameter to equal said (i)th current value minus said (i)th change value.

13. The article of manufacture of claim 12, said computer readable program code further comprising a series of computer readable program steps to effect if said adjusted I/O rate is not less than said current I/O rate, and if said iteration counter is not set to 1:
saving said (i)th I/O parameter as said (i)th current value;
setting said iteration counter to 0.

14. The article of manufacture of claim 12, wherein said article of manufacture further comprises a pre-determined direction vector for each of said one or more I/O parameters, wherein the (i)th direction vector comprises a value and a sign, wherein the (i)th direction vector sign is selected from the group consisting of positive and negative, said computer readable program code further comprising a series of computer readable program steps to effect:
adjusting the (i)th I/O parameter to equal said current value plus the multiplication product of said (i)th change value and said (i)th direction vector;
operative if said adjusted I/O rate is less than said current I/O rate and if said iteration counter is set to 1, changing the (i)th direction vector sign, and repeating said adjusting, saving, calculating, and determining steps.

15. A computer program product usable with a programmable computer processor having computer readable program code embodied therein to adjust one or more input/output parameters for a computing system comprising one or more variable I/O parameters, a pre-determined change value for each of said one or more I/O parameters, and a pre-determined stabilization period for each of said one or more I/O parameters, comprising:
computer readable program code which causes said programmable computer processor to ascertain a current I/O rate;
computer readable program code which causes said programmable computer processor to select the (i)th I/O parameter, wherein said (i)th I/O parameter is one of said one or more I/O parameters, and wherein said (i)th I/O parameter comprises the (i)th current value;
computer readable program code which causes said programmable computer processor to adjust the (i)th I/O parameter to equal said current value plus the (i)th change value;
computer readable program code which causes said programmable computer processor to calculate an adjusted I/O rate;
computer readable program code which causes said programmable computer processor to determining if said adjusted I/O rate is less than said current I/O rate;
computer readable program code which, if said adjusted I/O rate is less than said current I/O rate, causes said programmable computer processor to save said adjusted (i)th I/O parameter as said (i)th current value.

16. The computer program product of claim 15, wherein said information storage and retrieval system further comprises a pre-determined stabilization period for each of said one or more I/O parameters, further comprising computer readable program code which causes said programmable computer processor to implement the (i)th stabilization period after performing said adjusting step and before performing said calculating step.

17. The computer program product of claim 15, wherein said information storage and retrieval system further comprises a pre-determined minimum value and maximum value for each of said one or more I/O parameters, further comprising:
computer readable program code which causes said programmable computer processor to ascertain if said adjusted (i)th I/O parameter is greater than or equal to the (i)th minimum value and less than or equal to the (i)th maximum value;
computer readable program code which, if said adjusted (i)th I/O parameter is not greater than or equal to the (i)th minimum value or less than or equal to the (i)th maximum value, causes said programmable computer processor to set said (i)th I/O parameter equal to said (i)th current value;
computer readable program code which, if said adjusted (i)th I/O parameter is greater than or equal to the (i)th minimum value, and is less than or equal to the (i)th maximum value, causes said programmable computer processor to save said adjusted (i)th I/O parameter as the (i)th current value.

18. The computer program product of claim 17, wherein said information storage and retrieval system further comprises an iteration counter set to 0, further comprising:
computer readable program code which causes said programmable computer processor to increment said iteration counter after performing said adjusting step and before performing said determining step;
computer readable program code which, if said adjusted I/O rate is not less than said current I/O rate, causes said programmable computer processor to ascertain if said iteration counter is set to 1;
computer readable program code which, if said iteration counter is not set to 1, causes said programmable computer processor to set said (i)th I/O parameter to equal said (i)th current value minus said (i)th change value.

19. The computer program product of claim 18, further comprising:
computer readable program code which, if said adjusted I/O rate is not less than said current I/O rate, and if said iteration counter is not set to 1 causes said programmable computer processor to:
save said (i)th I/O parameter as said (i)th current value;
set said iteration counter to 0.

20. The computer program product of claim 18, wherein said information storage and retrieval system further comprises a pre-determined direction vector for each of said one or more I/O parameters, wherein the (i)th direction vector comprises a value and a sign, wherein the (i)th direction vector sign is selected from the group consisting of positive and negative, further comprising:
wherein said computer readable program code which causes said programmable computer processor to adjust the (i)th I/O parameter further comprises computer readable program code which causes said programmable computer processor to set said (i)th I/O parameter to equal said (i)th current value plus the multiplication product of said (i)th change value and said (i)th direction vector;
computer readable program code which, if said adjusted I/O rate is less than said current I/O rate and if said iteration counter is set to 1, causes said programmable computer processor to change the (i)th direction vector sign.
